(19) United States
(12) Patent Application Publication
(10) Pub. No.: US 2016/0136618 A1
(43) Pub. Date: May 19, 2016

(54) Sulfur-Resistant Synergized PGM Catalysts for Diesel Oxidation Application

(71) Applicants: Zahra Nazarpoor, Camarillo, CA (US); Stephen J. Golden, Santa Barbara, CA (US)

(72) Inventors: Zahra Nazarpoor, Camarillo, CA (US); Stephen J. Golden, Santa Barbara, CA (US)

(73) Assignee: CLEAN DIESEL TECHNOLOGIES, INC., Ventura, CA (US)

(21) Appl. No.: 14/548,035

(22) Filed: Nov. 19, 2014

(51) Int. Cl. B01J 23/44; B01J 35/00; B01J 23/10; B01J 21/04; B01J 23/42; B01D 53/94; B01J 23/34

(52) U.S. Cl. CPC B01J 23/44; B01D 53/9472; B01J 35/0006; B01J 23/34; B01J 21/04; B01J 23/42; B01J 23/10; B01D 2255/402; B01D 2255/1023; B01D 2255/1021; B01D 2255/2061; B01D 2255/2073; B01D 2255/20715; B01D 2255/2066; B01D 2255/2092

(57) ABSTRACT

Sulfur-resistant SPGM catalysts with significant oxidation capabilities are disclosed. A plurality of catalyst samples may be prepared including ZPGM material compositions of YMnO₃ perovskite supported on doped Zirconia and cordierite substrate, and front zoned with Pd and Pt/Pd compositions. Incipient wetness and metallizing techniques may be used for the catalytic layers. Testing of samples may be performed under standard and sulfated DOC conditions to assess influence of adding PGM to ZPGM catalyst samples. Levels of NO oxidation and HC oxidation may be compared. Resistance to sulfur and catalytic stability may be observed under long-term sulfated DOC condition to determine SPGM catalyst samples for DOC applications which may provide the most significant improvements in NO oxidation, HC conversion, CO selectivity, and long-term resistance to sulfur.

### CROSS-REFERENCE TO RELATED APPLICATIONS

The present disclosure is related to U.S. non-provisional patent application US 2013/0236380 A1 entitled “Palladium solid solution catalyst and methods of making”, invented by Stephen J. Golden, Randalph Hatfield, Jason D. Pless, and Johnny T. Ngo.

N/A

### BACKGROUND

1. Field of the Disclosure

This disclosure relates generally to catalyst materials for diesel oxidation applications, and more particularly, to sulfur resistant synergized PGM diesel oxidation catalysts for reduction of emissions from a plurality of diesel engine systems.

2. Background Information

Conventional DOCs are vulnerable to sulfur poisoning caused by sulfur-containing diesel fuels. In diesel engines some percent of SO₂ formed during combustion is oxidized to SO₃, which dissolves in the water vapor present to form sulfuric acid (H₂SO₄) vapor. This appears to be a major mechanism for initiation of particle formation in the exhaust, such that even though sulfate particles account for only a small fraction of particle volume or mass, they account for a large fraction in providing a relatively large surface area onto which HC species condense, resulting in particle growth and increasing particle toxicity.

Sulfur prevents the efficient functioning of certain types of catalysts and may also impede the viability of emissions control technologies in several diesel engine designs. Therefore, sulfur species are poisons for all catalytic processes employing reducing metals as the primary active phase. The effect of sulfur poisons may be permanent depending on the process conditions.

Sulfur may also cause significant deactivation even at very low concentrations, due to the formation of strong metal-sulfur bonds. Sulfur chemisorbs onto and reacts with the active catalyst sites. The stable metal-adsorbate bonds can lead to non-selective side reactions, which modify the surface chemistry. Thus, sulfur may impair the performance of a catalyst by reducing its activity, either via competitive adsorption onto active sites, or by alloy formation with active PGM sites. More stringent removal of harmful contaminants is therefore essential to achieve highest catalytic activity and selectivity. The effects of sulfur poisoning cannot be completely avoided, but can be reduced by a system designed to protect the PGM catalyst without incurring in unnecessary costs associated with a loss of process economics and catalyst regeneration or replacement. Poisoning of a catalyst with sulfur can be reduced by a sulfur getter, including platinum group metals (PGMs) as catalytically active components, inserted into the exhaust gas stream upstream of the catalyst. PGMs are used alone or in combination with other noble metals as active components in oxidation catalysts at ratios that depend on the configuration of the exhaust system in which the catalyst is to be used, but noble metals catalyze different oxidation reactions with different effectiveness.

Therefore, as emissions regulations become more stringent, there is significant interest in developing DOCs with improved properties for effective utilization and particularly with improved activity and stability. The increasing need for new compositions may include combined Zero PGM catalyst systems with low loading PGM catalysts, exhibiting a synergistic behavior in yielding enhanced catalyst activity and sulfur resistance under diesel oxidation condition, and which may be cost-effectively manufactured.

### SUMMARY

The present disclosure may provide DOC system configurations of synergized PGM (SPGM) catalysts to assist in the removal of sulfur species from the engine out, and confirm that disclosed DOC formulations may be optimized to minimize generation of sulfate particulates in applications with sulfur-containing fuels and for the reduction of diesel PMs. The incorporation of sulfur-based deactivation in the design of DOC applications may provide directions leading into the development of sulfur resistant catalyst compositions for DOC applications.

It is an object of the present disclosure to confirm and/or verify that PGM catalysts alone and ZPGM catalysts alone may not show a high sulfur resistance as SPGM catalyst systems, which may be synergized PGM with ZPGM catalyst compositions. The disclosed SPGM catalysts may provide SPGM catalyst systems of significantly high sulfur resistance.

In an aspect of the present disclosure, the SPGM catalyst systems may include catalyst samples of ZPGM zoned with PGM. According to embodiments in present disclosure, ZPGM catalyst systems may be configured to include at least a washcoat (WC) layer of Zero-PGM (ZPGM) catalyst material on doped support oxide, with selected base metal loadings, coated on cordierite substrate. ZPGM catalysts may be formed using an YMnO₃ perovskite structure on doped ZrO₂ support oxide. The incipient wetness (IW) technique may be used to make powder of YMnO₃ perovskite on doped ZrO₂, and subsequent deposition of this powder on cordierite substrate.

The present PGM may include at least a WC layer, where the WC layer may be prepared with Pd catalyst material and OSM with Barium (Ba) and Cerium (Ce), as provided in U.S. patent application US 2013/0236380 A1, entitled “Palladium solid solution catalyst and methods of making”, or the WC layer may include alumina metallized with a solution of Pt/Pd.

Embodiments in present disclosure may use SPGM catalysts in DOC applications with high NO oxidation activity and resistant to sulfur poisoning. DOC light-off test of PGM may be performed to assess synergistic effects of ZPGM in SPGM configuration. The sulfur resistance of SPGM catalyst samples may be tested according to a test methodology under isothermal DOC condition and sulfated DOC condition at space velocity (SV) of about 54,000 h⁻¹.

The DOC/sulfur test may provide significant improvements using SPGM catalysts. Therefore, NO, HC, and CO conversions from the catalysts may be determined and compared to confirm any significant improvement in sulfur resistance of ZPGM versus SPGM samples. Additionally, comparison in NO oxidation may assist in determining, under isothermal DOC condition and sulfated DOC condition, the effect of adding low level of PGM to the YMnO₃ perovskite structure, as well as in verifying the SPGM configuration which may show significant improvement in selectivity of CO and NO oxidation stability before and after sulfation. Additional testing under sulfated DOC condition may be performed to observe the long-term sulfur resistance of the SPGM catalyst providing the most significant activity and stability for NO oxidation and HC conversion.

Numerous other aspects, features, and benefits of the present disclosure may be made apparent from the following detailed description taken together with the drawing figures, which may illustrate the embodiments of the present disclosure, incorporated here for reference.

### BRIEF DESCRIPTION OF THE DRAWINGS

The present disclosure can be better understood by referring to the following figures. The components in the figures are not necessarily to scale, emphasis instead being place upon illustrating the principles of the disclosure. In the figures, reference numerals designate corresponding parts throughout the different views.

FIG. 1 depicts catalyst configurations for ZPGM and SPGM catalyst test methodology. FIG. 1A shows a catalyst configuration for a 3″ ZPGM catalyst sample and FIG. 1B depicts a catalyst configuration of SPGM catalyst including a 1″ PGM and a 2″ ZPGM catalyst sample, according to an embodiment.

FIG. 2 depicts catalyst configurations for control samples of PGM and ZPGM. FIG. 2A shows catalyst configuration for control sample of PGM including a 1″ PGM and a 2″ blank of cordierite substrate, and FIG. 2B illustrates catalyst configuration for a control sample of ZPGM including a 1″ blank of cordierite substrate and a 2″ ZPGM sample, according to an embodiment.

FIG. 3 illustrates catalyst activity, DOC light-off (LO) testing for a control sample of PGM including 1″ Pd and 2″ blank of cordierite substrate, tested with a DOC test methodology employing a standard gas stream composition under DOC LO and soaking at isothermal DOC condition, at about 340° C. and space velocity (SV) of about 54,000 h⁻¹, according to an embodiment.

FIG. 4 shows catalyst activity, DOC LO testing, for a control sample of PGM including 1″ of Pt/Pd and 2″ blank of cordierite substrate, tested with DOC test methodology employing a standard gas stream composition under DOC LO and soaking at isothermal DOC condition, at about 340° C. and space velocity (SV) of about 54,000 h⁻¹, according to an embodiment.

FIG. 5 depicts catalyst activity comparison in NO oxidation, HC conversion, and CO conversion for control samples of ZPGM including 1″ blank of cordierite substrate and 2″ ZPGM catalyst versus SPGM catalyst system including 1″ Pt/Pd and 2″ ZPGM catalyst, tested according to DOC test methodology employing a standard gas stream composition under isothermal standard DOC condition at about 340° C. and SV of about 54,000 h⁻¹, according to an embodiment.

FIG. 6 illustrates catalyst activity comparison in NO oxidation, HC conversion, and CO comparison for control samples ZPGM including 1″ blank of cordierite substrate and 2″ ZPGM catalyst versus SPGM catalyst including 1″ Pd and 2″ ZPGM catalyst, tested according to DOC test methodology employing a standard gas stream composition under isothermal standard DOC condition at about 340° C. and SV of about 54,000 h⁻¹, according to an embodiment.

FIG. 7 reveals the NO conversion under isothermal DOC test condition for ZPGM catalyst sample versus SPGM catalyst system including different types of front zone PGM, before and after adding SO₂, at about 340° C. and SV of about 54,000 h⁻¹, according to an embodiment.

FIG. 8 shows long-term sulfur resistance test comparing NO oxidation activity for SPGM1 samples including Pd and YMnO₃ perovskite versus ZPGM catalyst including YMnO₃ perovskite, under isothermal sulfated DOC condition at about 340° C. and SV of about 54,000 h⁻¹, flowing about 3 ppm SO₂ for about 7 hours, according to an embodiment.

FIG. 9 shows long-term sulfur resistance test comparing HC conversion for SPGM1 samples including Pd and YMnO₃ perovskite versus ZPGM catalyst including YMnO₃ perovskite, under isothermal sulfated DOC condition at about 340° C. and SV of about 54,000 h⁻¹, flowing about 3 ppm SO₂ for about 7 hours, according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### DEFINITIONS

As used here, the following terms may have the following definitions:

“Catalyst” refers to one or more materials that may be of use in the conversion of one or more other materials.

“Catalyst system” refers to any system including a catalyst, such as a Platinum Group Metal (PGM) catalyst, or a Zero-PGM (ZPGM) catalyst a system, of at least two layers including at least one substrate, a washcoat, and/or an overcoat.

“Platinum group metals (PGM)” refers to platinum, palladium, ruthenium, iridium, osmium, and rhodium.

“Zero PGM (ZPGM) catalyst” refers to a catalyst completely or substantially free of platinum group metals.

“Synergized PGM (SPGM) catalyst” refers to a PGM catalyst system which is synergized by a non-PGM group metal compound under different configuration.

“Diesel oxidation catalyst” refers to a device which utilizes a chemical process in order to break down pollutants from a diesel engine or lean burn gasoline engine in the exhaust stream, turning them into less harmful components.

“Oxygen storage material (OSM)” refers to a material/composition able to take up oxygen from oxygen rich streams and able to release oxygen to oxygen deficient streams, thus buffering a catalyst system against the fluctuating supply of oxygen to increase catalyst efficiency.

“Support oxide” refers to porous solid oxides, typically mixed metal oxides, which are used to provide a high surface area which aids in oxygen distribution and exposure of catalysts to reactants such as NO_{R}, CO, and hydrocarbons.

“Perovskite” refers to a ZPGM catalyst, having ABO₃ structure of material which may be formed by partially substituting element “A” and “B” base metals with suitable non-platinum group metals.

“Metallizing” refers to the process of coating metal on the surface of metallic or non-metallic objects.

“Conversion efficiency” refers to the percentage of emissions passing through the catalyst that are converted to their target compounds.

“Poisoning or catalyst poisoning” refers to the inactivation of a catalyst by virtue of its exposure to lead, phosphorus, or sulfur in an engine exhaust.

### DESCRIPTION OF THE DRAWINGS

Embodiments of the present disclosure may use synergized PGM (SPGM) to enhance performance and sulfur resistance of catalysts in diesel engine applications. The present disclosure is directed to diesel oxidation catalyst (DOC) system configurations of SPGM including Zero-PGM (ZPGM) catalysts zoned with PGM, using methodologies which may assist in the removal of sulfur species from the diesel engine out, and confirm that disclosed DOC formulations may lead into the development of sulfur resistant materials for DOC applications.

Catalyst Structures for Analysis of SPGM Catalyst System

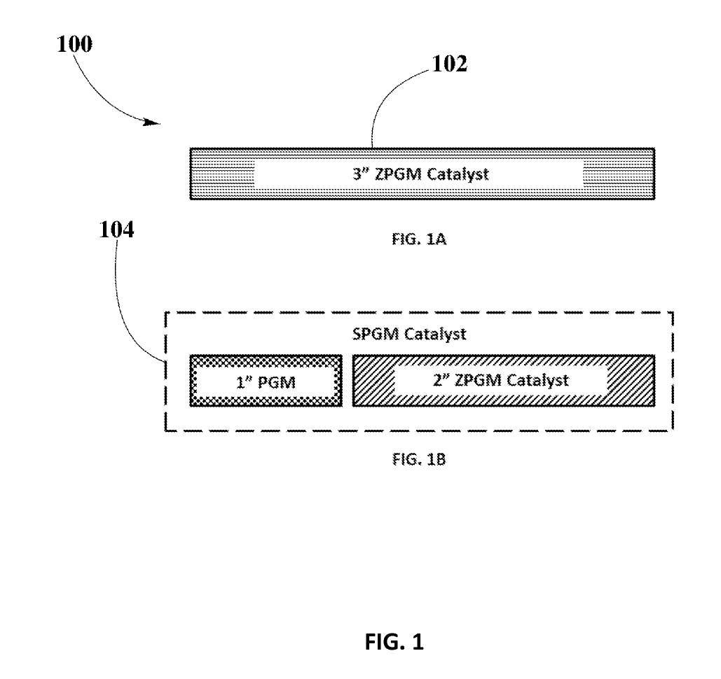

FIG. 1 represents catalyst structures 100 of ZPGM and SPGM catalyst samples for catalyst test methodology. FIG. 1A shows catalyst structure 102 for a length of 3″ long ZPGM catalyst sample including YMnO₃ perovskite structure on doped ZrO2 support oxide. FIG. 1B depicts catalyst structure 104 for a length of 3″ long SPGM catalyst sample configured with zoned coating of a length of 1″ long PGM and a length of 2″ long ZPGM catalyst of YMnO₃ perovskite structure on doped ZrO2 support oxide. The PGM front zone may be Pd-based or Pt/Pd-based catalyst sample. The SPGM catalyst sample including a Pd as PGM layer is here identified as SPGM1 and the SPGM catalyst sample including a Pt/Pd as PGM layer is here identified as SPGM2. All samples may have a 1″ diameter.

Configuration, Material Composition, and Preparation of SPGM Catalysts

According to embodiments in present disclosure, ZPGM catalyst samples may be prepared including a WC layer of YMnO₃ material composition deposited on doped ZrO₂ support oxide on cordierite substrate. Preparation of the WC layer may start by preparing a Y—Mn solution mixing the appropriate amount of Y nitrate solution and Mn nitrate solution with water to make solution at appropriate molar ratio. Then, the Y—Mn solution may be added to Pr₆O₁₁—ZrO₂ powder by IW technique. Subsequently, mixture powder may be dried and calcined at about 700° C. for about 5 hours, and then ground to fine grain for bulk powder. Bulk powder of YMnO₃/Pr₆O₁₁—ZrO₂ may be milled with water separately to make slurry, then coated on cordierite substrate and calcined at 700° C. for about 5 hours.

A PGM layer may include a WC layer of Pd and OSM with Barium (Ba) and Cerium (Ce). The OSM may include zirconia, lanthanides, alkaline earth metals, transition metals, cerium oxide materials, or mixtures thereof. In this embodiment, OSM include Ba and Ce, which may help in retarding the poisoning and deactivation of the catalyst system by sulfur. The Pd sample may be prepared as described in U.S. Patent Application US 2013/0236380, incorporated here by reference. The Pd sample may be coat on front 1″ length of total SPGM1 catalyst system. The amount of Pd in full length of catalyst bed (3″) may be approximately about 6.6 g/ft³.

A PGM sample may also include a WC layer of Pt/Pd catalyst material on cordierite substrate. The Pt/Pd layer may be prepared by making a solution of Pt nitrate and Pd nitrate using the specific molar ratios, then milling alumina separately for metallizing with the Pt/Pd solution. Subsequently, Pt/Pd and alumina may be coated on the substrate and calcined at 550° C. for about 4 hours. The Pt/Pd layer may be coat on front 1″ length of the total SPGM2 catalyst system. The amount of Pt/Pd in full length of catalyst bed (3″) may be approximately about 3.3 g/ft³ Pt and about 0.18 g/ft³ Pd.

Catalyst Structures for PGM and ZPGM Control Samples

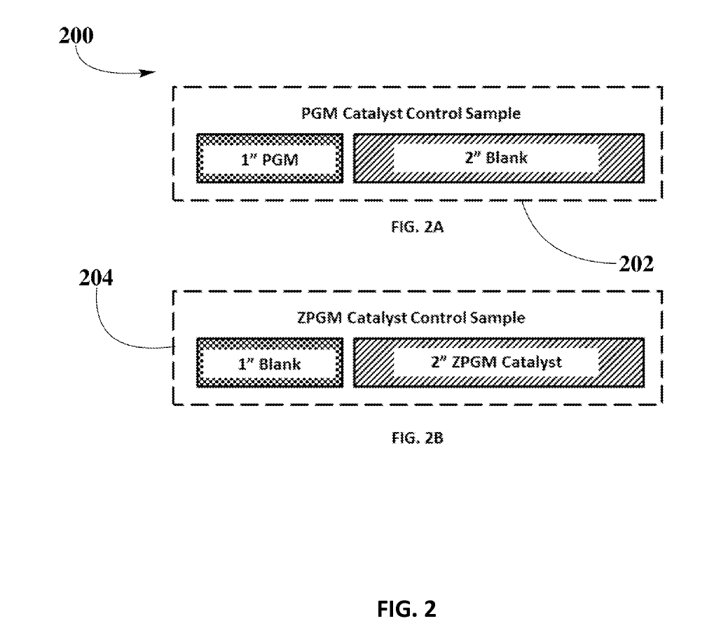

FIG. 2 depicts catalyst structures 200 for control samples for catalyst test methodology. FIG. 2A shows catalyst structure 202 for control samples configured with a length of 1″ long PGM, as described in FIG. 1, and a length of 2″ long blank of cordierite substrate, here identified as PGM control sample. FIG. 2B illustrates catalyst structure 204 for control samples configured with a length of 1″ long blank of cordierite substrate and a length of 2″ long ZPGM catalyst sample, as previously described, here identified as ZPGM control sample. All control samples may have a 1″ diameter.

ZPGM catalyst samples, SPGM catalyst samples, and PGM and ZPGM control samples may be tested under isothermal DOC condition and sulfated DOC condition. Additionally, performance in NO oxidation and HC conversion of samples in present disclosure may be determined and compared to confirm significant results in sulfur resistance according to a DOC/sulfur test methodology.

DOC/Sulfur Test Methodology

DOC/sulfur test methodology may be applied to ZPGM catalyst, SPGM catalyst systems and control samples as described in FIG. 1 and FIG. 2. The test methodology may enable confirmation of desirable and significant properties of the disclosed catalyst systems including ZPGM (YMnO₃ perovskite structure) with a PGM front zone for DOC applications. The variety catalyst samples in present disclosure may confirm that SPGM prepared with low amount of PGM added to ZPGM catalyst materials may be capable of providing significant improvements in sulfur resistance.

Testing under steady state DOC condition may start with DOC light-off test, performed under DOC gas composition while temperature increases from 100° C. to 340° C. and soaking isothermally at about 340° C., employing a flow reactor with flowing gas composition of about 100 ppm of NO, about 1,500 ppm of CO, about 4% of CO₂, about 4% of H₂O, about 14% of O₂, and about 430 ppm of C₃H₆, at space velocity (SV) of about 54,000 h⁻¹. For isothermal sulfated DOC condition, a concentration of about 3 ppm of SO₂ may be added to the gas stream for about 3 hours. Additional testing under sulfated DOC condition may be performed to observe the long-term sulfur resistance of catalyst samples by adding to the gas stream a concentration of about 3 ppm of SO₂ for about 7 hours.

Catalyst Activity of PGM Control Samples Under DOC Condition

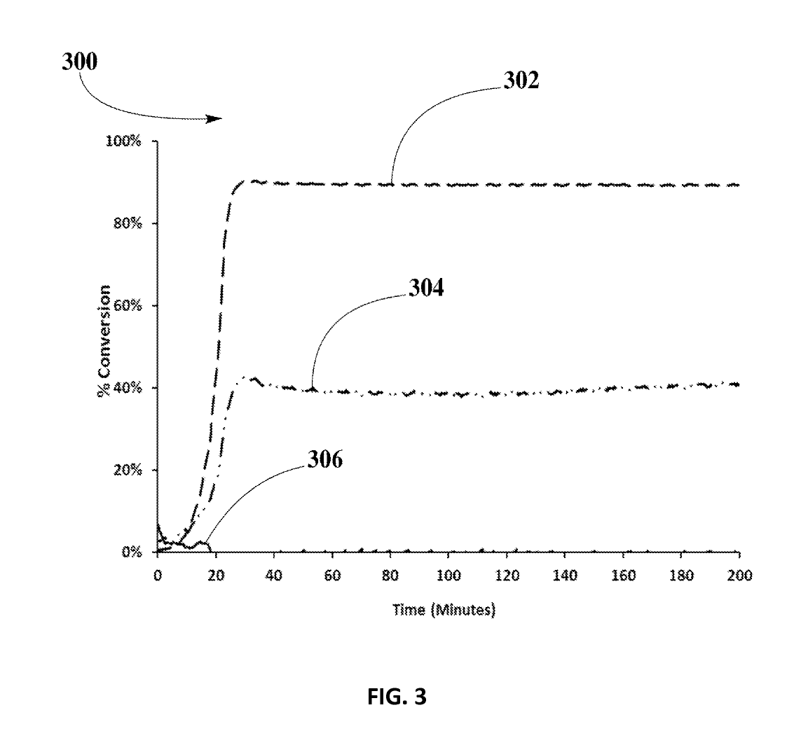

FIG. 3 illustrates catalyst activity 300, DOC light-off (LO) testing for a PGM control sample including 1″ Pd and 2″ blank of cordierite substrate, tested with DOC test methodology employing a standard gas stream composition under DOC LO and soaking at isothermal DOC condition for about 3 hours, at about 340° C. and space velocity (SV) of about 54,000 h⁻¹, according to an embodiment.

As can be seen in FIG. 3, conversion curve 302 represent % CO conversion, conversion curve 304 depicts % HC conversion, and conversion curve 306 shows % NO oxidation. It may be observed that under DOC condition, the Pd front zone by itself does not present any NO conversion at 340° C. It may also be observed that CO conversion and HC conversion are in levels of about 89.2% and about 40.7%, respectively at 340° C.

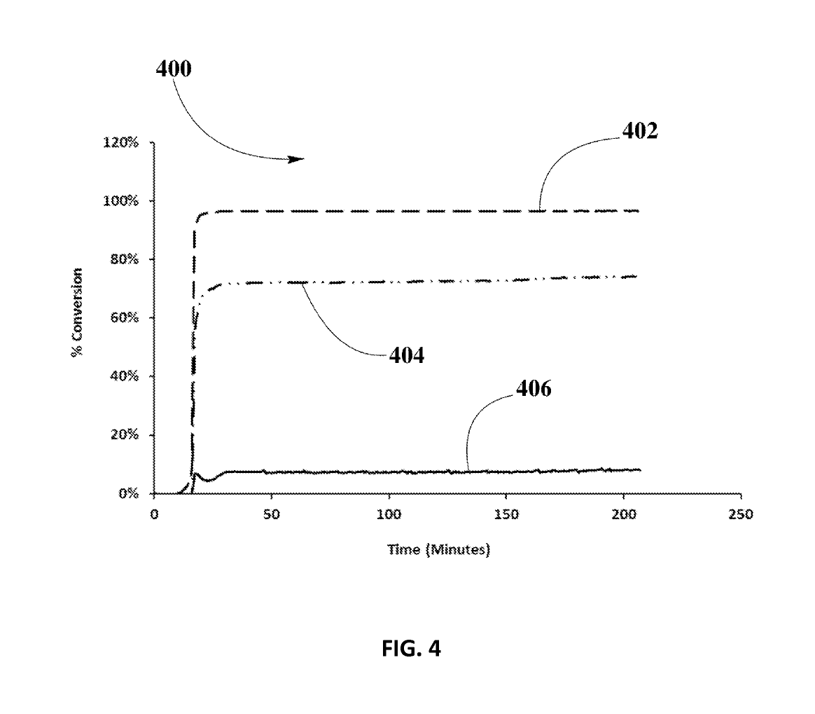

FIG. 4 shows catalyst activity 400, DOC LO testing, for a PGM control sample including 1″ of Pt/Pd and 2″ blank of cordierite substrate, tested with DOC test methodology employing a standard gas stream composition under DOC LO and soaking at isothermal DOC condition for about 3 hours, at about 340° C. and space velocity (SV) of about 54,000 h-1, according to an embodiment.

As can be seen in FIG. 4, conversion curve 402 represent % CO conversion, conversion curve 404 depicts % HC conversion, and conversion curve 406 shows % NO oxidation. It may be observed that under DOC condition at about 340° C., the Pt/Pd front zone shows a minimum level of NO conversion of about 8.1%, while CO conversion and HC conversion are in levels of about 96.6% and about 74.2%, respectively.

As may be seen from FIG. 3 and FIG. 4, both types of PGM control samples may provide significant levels of CO and HC conversion efficiency and stability. As noted, while % NO conversion may be confirmed to be practically none, % CO conversions observed may reach levels within a range of about 90% and above, showing enhanced CO oxidation performance. Similar behavior activity may be observed for HC conversion, with the highest level observed for the Pt/Pd control sample compare to Pd control sample.

Catalyst Activity of ZPGM and SPGM Samples Under DOC Condition

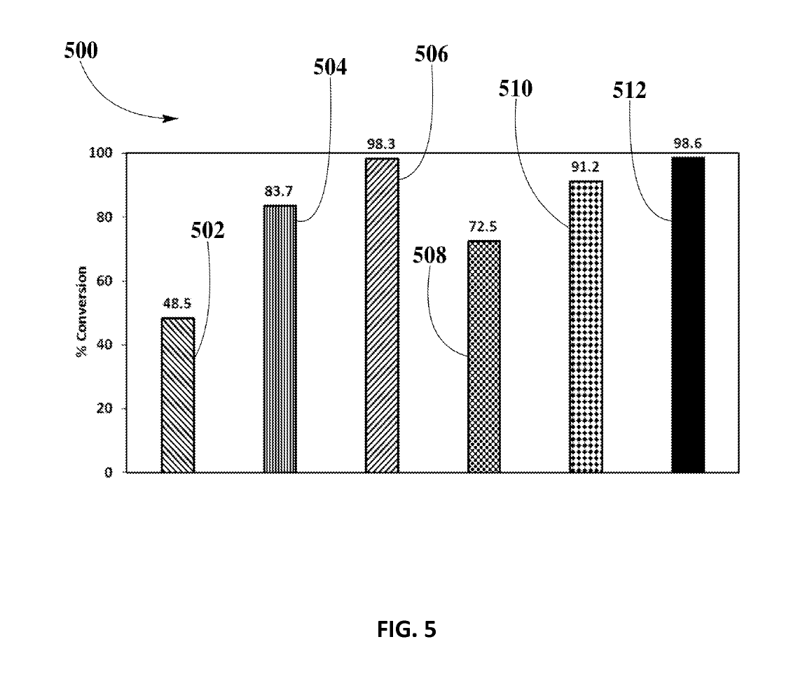

FIG. 5 depicts catalyst activity comparison 500 in NO oxidation, HC conversion, and CO conversion for ZPGM control samples including 1″ blank of cordierite substrate and 2″ ZPGM catalyst versus SPGM2 catalyst samples including 1″ Pt/Pd and 2″ ZPGM, tested according to DOC test methodology employing a standard gas stream composition under isothermal standard DOC condition at about 340° C. and SV of about 54,000 h⁻¹, according to an embodiment.

As can be seen in FIG. 5, bar 502, bar 504, and bar 506 show levels of NO conversion, HC conversion and CO conversion, respectively, for ZPGM control sample. Similarly, bar 508, bar 510, and bar 512 show levels of NO conversion, HC conversion and CO conversion, respectively, for zoned SPGM2 catalyst sample.

As may be seen in catalyst activity comparison 500, under DOC condition, bar 502 shows 48.5% NO conversion, bar 504 shows 83.7% HC conversion, and bar 506 shows 98.3% CO conversion for ZPGM control sample. Bar 508 depicts a 72.5% NO conversion, bar 510 depicts 91.2% HC conversion, and bar 512 depicts 98.6% CO conversion for zoned SPGM2 catalyst sample.

It may be observed, that under isothermal DOC condition, there is a significant improvement in NO oxidation as a result of adding Pt/Pd front zoned to YMnO₃ catalyst in SPGM2 catalyst system. The Pt/Pd control sample shows a very low % NO conversion as shown in FIG. 4; the YMnO₃ ZPGM control sample tested alone shows 48.5% NO conversion; and the SPGM2 catalyst sample presents a significant increase in NO conversion of 72.5% by adding front zone of Pt/Pd to the YMnO₃ ZPGM.

These results show significant improvement of NO oxidation at 340° C. by combining ZPGM catalyst with a Pt/Pd front zone. The Pt/Pd front zoned may be applied in a single bed SPGM catalyst with a front coating of Pt/Pd continued by ZPGM material.

The latter may confirm the effect of adding Pt/Pd to ZPGM layer in improving NO oxidation of SPGM. Testing of Pt/Pd sample alone provides a 74.2% HC conversion, while testing YMnO₃ ZPGM catalyst alone presents HC conversion of 83.7%. Testing of front zoned SPGM2 results in HC conversion significantly increased to 91.2%, as seen in FIG. 5, indicating that the resistance of HC conversion in YMnO₃ perovskite increased by adding Pt/Pd in front bed. Additionally, testing of Pt/Pd sample alone provides 96.6% CO conversion and testing of the ZPGM catalyst sample alone presents CO conversion of 98.3%, while testing of front zoned SPGM2 results in CO conversion of 98.6%.

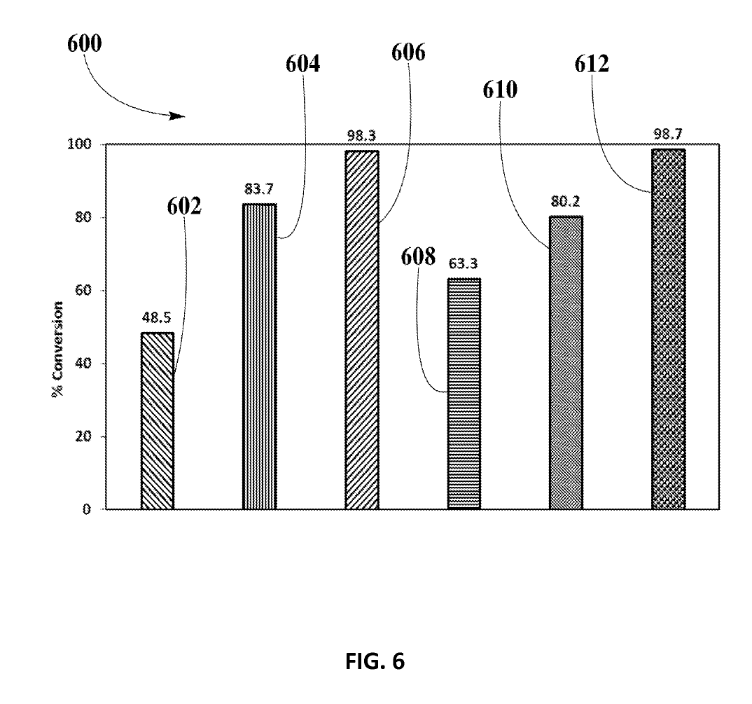

FIG. 6 illustrates catalyst activity comparison 600 in NO oxidation, HC conversion, and CO comparison for ZPGM control samples including 1″ blank of cordierite substrate and 2″ ZPGM catalyst versus zoned SPGM1 including 1″ Pd and 2″ ZPGM, tested according to DOC test methodology employing a standard gas stream composition under isothermal standard DOC condition at about 340° C. and SV of about 54,000 h⁻¹, according to an embodiment.

As can be seen in FIG. 6, bar 602, bar 604, and bar 606 show levels of NO conversion, HC conversion and CO conversion, respectively, for ZPGM control sample. Similarly, bar 608, bar 610, and bar 612 show levels of NO conversion, HC conversion and CO conversion, respectively, for SPGM1 catalyst sample.

As may be seen in catalyst activity comparison 600, under DOC condition, bar 602 shows 48.5% NO conversion, bar 604 shows 83.7% HC conversion, and bar 606 shows 98.3% CO conversion for ZPGM control sample. Bar 608 depicts a 63.3% NO conversion, bar 610 depicts 80.2% HC conversion, and bar 612 depicts 98.7% CO conversion for SPGM1 catalyst sample.

It may be observed, that under isothermal DOC condition, there is a significant improvement in NO oxidation as a result of adding Pd front zoned to same YMnO₃ structure used for SPGM2 catalyst system. The Pd control sample shows practically none NO conversion as shown in FIG. 3; the YMnO₃ ZPGM catalyst tested alone shows 48.5% NO conversion; and the SPGM1 catalyst sample presents a significant increase in NO conversion of 63.3%.

These results show significant improvement of NO oxidation at 340° C. by combining ZPGM catalyst with a Pd catalyst front zone. The Pd front zoned may be applied in a single bed SPGM catalyst with a front coating of Pd continued by ZPGM material.

The latter may confirm the effect of adding Pd to ZPGM layer in improving NO oxidation of SPGM. Testing of Pd sample alone provides a 40.7% HC conversion, while testing of YMnO₃ ZPGM catalyst alone presents HC conversion of 83.7%. Testing of front zoned SPGM1 results in an HC conversion level which practically remained unchanged and reached 80.2%, as seen in FIG. 6, indicating that the resistance of HC conversion in YMnO₃ perovskite does not change by adding Pd in front bed. Additionally, testing of Pd sample alone provides 89.2% CO conversion and testing of the YMnO₃ ZPGM catalyst alone presents CO conversion of 98.3%, while testing of front zoned SPGM1 results in CO conversion of 98.7%.

As may be seen from FIG. 5 and FIG. 6, SPGM catalyst samples may have significant improvement in NO conversion and stability as a result of the adding front zone PGM to YMnO₃ ZPGM in present disclosure. The front zone PGM is very selective for CO and HC conversion, which may explain the significant improvement of NO oxidation in SPGM catalyst system.

NO Oxidation Stability of Sulfated SPGM Catalyst Samples

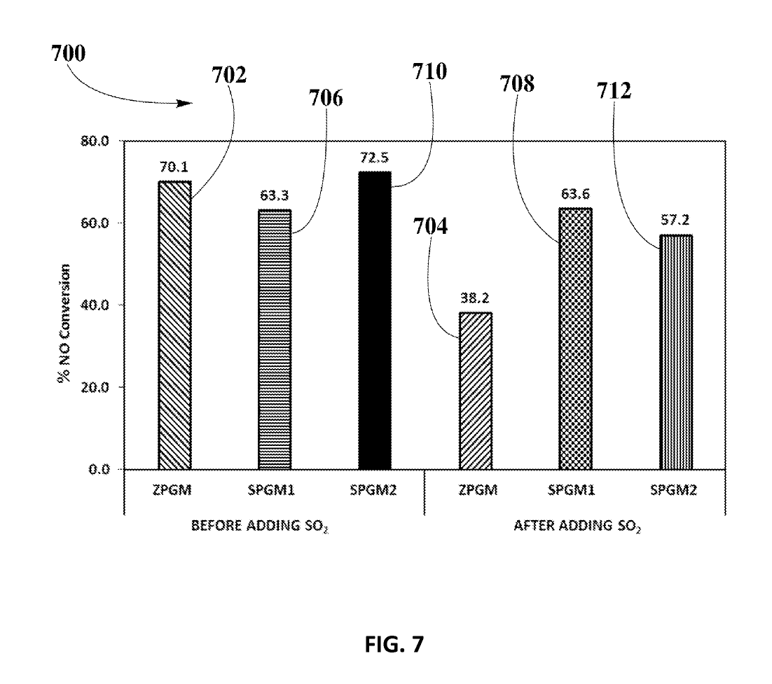

FIG. 7 reveals the NO conversion under isothermal DOC test condition for ZPGM catalyst sample versus SPGM1 and SPGM2 catalyst systems, before and after adding SO₂, at temperature of about 340° C. and SV of about 54,000 h⁻¹, according to an embodiment.

In this embodiment NO oxidation comparison 700 may be performed for ZPGM catalyst sample versus SPGM1 and SPGM2 catalyst systems.

ZPGM is a 3″ YMnO₃ ZPGM catalyst sample according to FIG. 1A, SPGM1 is SPGM catalyst system with Pd front zone, and SPGM2 is SPGM catalyst system with Pt/Pd front zone, as previously described. The respective levels of NO oxidation for these catalyst samples, as shown in FIG. 7, correspond to % NO conversion before and after adding about 3 ppm SO₂ to gas stream during about 3 hours of isothermal DOC test condition at 340° C.

As may be seen in NO oxidation comparison 700, under standard DOC condition, bar 702 shows 70.1% NO conversion for ZPGM catalyst system, but after adding SO₂ to gas stream, NO conversion drops to 38.2%, as presented in bar 704, showing the ZPGM with YMnO₃ perovskite structure does not show resistance after sulfation. However, bar 706 shows 63.3% NO conversion for SPGM1 under standard DOC condition, but after sulfation NO conversion remains constant at approximately 63.6%, as shown in bar 708, indicating the effect of adding Pd layer to YMnO₃ perovskite increased the resistance of SPGM catalyst to sulfur, as verified by the resulting NO conversion levels, which practically remain constant before and after adding sulfur to the gas stream. Bar 710 shows 72.5% NO conversion for SPGM2 under standard DOC condition, but after sulfation, NO conversion drops to 57.2%, as presented in bar 712, showing that SPGM2 with Pt/Pd layer added to YMnO₃ perovskite shows better sulfur resistance when compared to ZPGM catalyst, however, the sulfur resistance of SPGM1 is better than SPGM2, indicating better stability of Pd zoned ZPGM compared to Pt/Pd zoned ZPGM.

The effect of adding Pd to YMnO₃ catalyst samples (SPGM1) and its significant resistant to sulfur may be verified by the resulting NO conversion levels, which practically remain constant before and after adding sulfur to the gas stream. YMnO₃ ZPGM catalyst samples front zoned with Pt/Pd (SPGM2) may not show as sulfur resistant as YMnO₃ catalyst samples front zoned with Pd (SPGM1), however, still show significant improvement in sulfur resistance as compared to ZPGM catalyst system.

Long-Term Sulfur Resistance of SPGM Catalysts

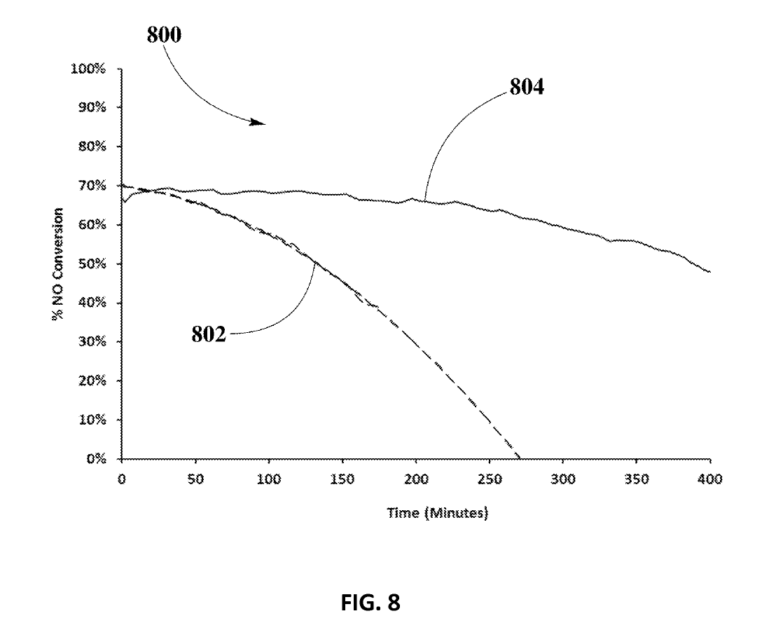

FIG. 8 shows long-term sulfur resistance test comparing NO oxidation activity for SPGM1 catalyst sample including Pd and YMnO₃ perovskite versus YMnO₃ ZPGM catalyst sample, under isothermal sulfated DOC condition at about 340° C. and SV of about 54,000 h⁻¹, flowing about 3 ppm SO₂ for about 7 hours which is equivalent to about 2.9 g sulfur per liter of substrate, according to an embodiment.

In FIG. 8, NO oxidation comparison 800 shows NO conversion curve 802 for YMnO₃ ZPGM catalyst samples and NO conversion curve 804 for SPGM1 catalyst sample. The effect of long-term sulfation may be verified by a significant decrease in NO conversion of ZPGM catalyst sample, indicating after flowing SO₂ for about 3 hours, the NO conversion decreased from approximately 70% to 38.2%, as seen in NO conversion curve 802. As sulfation exposure time may continue, fitting of NO conversion curve 802 may lead to infer that after a period of sulfation exposure for about 4 hours, no NO oxidation may occur, which may confirm that the YMnO₃ catalyst sample does not appear to be resistant to sulfur.

As seen in NO conversion curve 804, long-term sulfation exposure of SPGM1, after about 3 hours flowing SO₂, the NO conversion is presented an almost constant 63.6% and after about 7 hours of sulfated DOC condition testing, a 50% NO conversion level may be registered, which may indicate a good stability of the SPGM1 catalyst sample and significant sulfur resistance improved by adding Pd layer to ZPGM in present disclosure.

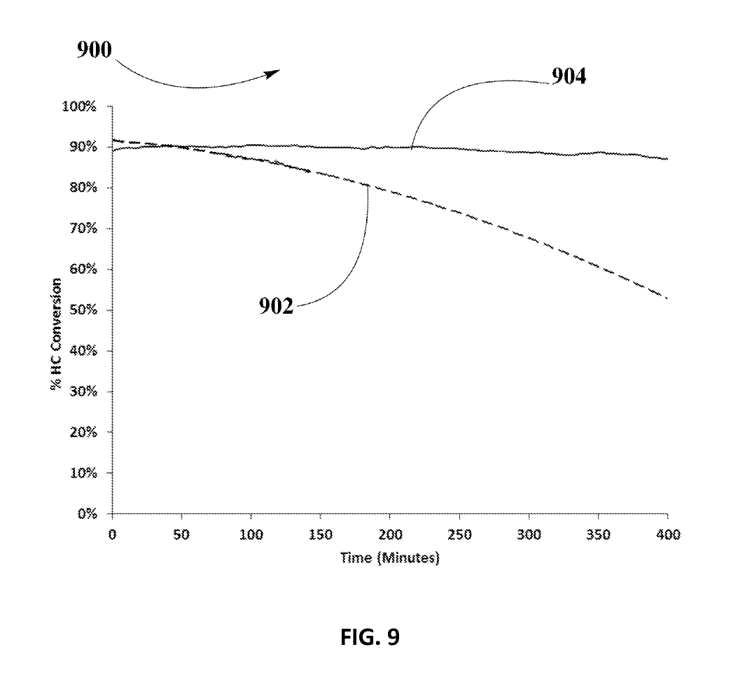

FIG. 9 shows long-term sulfur resistance test comparing HC conversion for SPGM1 sample including Pd and YMnO₃ perovskite versus YMnO₃ ZPGM catalyst sample, under isothermal sulfated DOC condition at about 340° C. and SV of about 54,000 h⁻¹, flowing about 3 ppm SO₂ for about 7 hours which is equivalent to 2.9 g sulfur per lit of substrate, according to an embodiment.

In FIG. 9, HC conversion comparison 900 shows HC conversion curve 902 for YMnO₃ ZPGM catalyst samples and HC conversion curve 904 for SPGM1. The effect of long-term sulfation may be verified by a significant decrease in HC conversion by YMnO₃ catalyst sample to about 50% after flowing SO₂ for about 7 hours, as may be seen in HC conversion curve 902, while in the same period of time SPGM1 presented an almost constant HC conversion of about 90%, as may be seen in HC conversion curve 904.

The results achieved during testing of the variety catalyst samples in present disclosure may confirm that SPGM prepared with low amount of PGM added to ZPGM catalyst materials may be capable of providing significant improvements in sulfur resistance of SPGM catalyst systems. As seen, although initial activity is the same, HC conversion is shown to be more stable in case of SPGM catalysts after sulfation period.

The diesel oxidation property of disclosed SPGM catalyst systems may provide an indication that under lean conditions their chemical composition may be more efficient operationally-wise, and from a catalyst manufacturer's viewpoint, an essential advantage given the economic factors involved in using YMnO₃ perovskite as synergizing catalyst material to PGM. The SPGM catalyst samples may be significantly active for CO selectivity, and NO and HC oxidation for DOC applications and show very good sulfur resistance.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

1. A synergized platinum group metal (SPGM) catalyst system comprising:
a) a first catalyst comprising a platinum group metal (PGM) washcoat layer and a first substrate; and
b) a second catalyst comprising a zero platinum group metal (ZPGM) washcoat layer and a second substrate;
wherein the PGM catalyst is upstream of the ZPGM catalyst.

2. The SPGM catalyst of claim 1, wherein the ZPGM washcoat layer further comprises a doped support oxide.

3. The SPGM catalyst of claim 2, wherein the support oxide is a doped ZrO₂ support oxide.

4. The SPGM catalyst of claim 2, wherein the ZPGM washcoat layer further comprises base metal loadings.

5. The SPGM catalyst of claim 1, wherein the SPGM is a YMnO₃ perovskite.

6. The SPGM catalyst of claim 1, wherein the first substrate is a cordierite substrate.

7. The SPGM catalyst of claim 1, wherein the PGM washcoat layer comprises palladium, platinum, or both palladium and platinum.

8. The SPGM catalyst of claim 1, wherein the PGM washcoat layer further comprises an oxygen storage material (OSM).

9. The SPGM catalyst of claim 2, wherein the OSM comprises zirconia, lanthanides, alkaline earth metals, transition metals, or mixtures thereof.

10. The SPGM catalyst of claim 1, wherein the PGM washcoat layer further comprises Al₂O₃.

11. The SPGM catalyst of claim 1, wherein the PGM zone to ZPGM zone ratio is a 1:2 ratio in diameter.

12. The SPGM catalyst of claim 2, wherein the support oxide is a Pr₆O₁₁—ZrO₂ support oxide.

13. The SPGM catalyst of claim 9, wherein the OSM comprises barium or cerium.

14. The SPGM catalyst of claim 1, wherein the second substrate is a cordierite substrate.

15. A diesel oxidation catalyst (DOC) system comprising the synergized platinum group metal catalyst system according to claim 1.

16. A method of reducing sulfur poisoning comprising applying an exhaust gas stream to a synergized platinum group metal (SPGM) catalyst system comprising:
a) a first catalyst comprising a platinum group metal (PGM) washcoat layer and a first substrate; and
b) a second catalyst comprising a zero platinum group metal (ZPGM) washcoat layer and a second substrate;
wherein the PGM catalyst is upstream of the ZPGM catalyst.

17. The method of claim 16, wherein the ZPGM washcoat layer further comprises a doped support oxide.

18. The method of claim 17, wherein the support oxide is a doped ZrO₂ support oxide.

19. The method of claim 17, wherein the ZPGM washcoat layer further comprises base metal loadings.

20. The method of claim 16, wherein the SPGM is a YMnO₃ perovskite.

21. The method of claim 16, wherein the first substrate is a cordierite substrate.

22. The method of claim 16, wherein the PGM washcoat layer comprises palladium, platinum, or both palladium and platinum.

23. The method of claim 16, wherein the PGM washcoat layer further comprises an oxygen storage material (OSM).

24. The method of claim 17, wherein the OSM comprises zirconia, lanthanides, alkaline earth metals, transition metals, or mixtures thereof.

25. The method of claim 16, wherein the PGM washcoat layer further comprises Al₂O₃.

26. The method of claim 16, wherein the PGM zone to ZPGM zone ratio is a 1:2 ratio in diameter.

27. The method of claim 17, wherein the support oxide is a Pr₆O₁₁—ZrO₂ support oxide.

28. The method of claim 24, wherein the OSM comprises barium or cerium.

29. The method of claim 16, wherein the second substrate is a cordierite substrate.

30. A method of reducing sulfur poisoning comprising applying an exhaust gas stream to the diesel oxidation catalyst (DOC) system according to claim 15.

31. The SPGM catalyst of claim 1, wherein the SPGM catalyst converts about 90% of hydrocarbons.

32. The SPGM catalyst of claim 31, wherein the about 90% conversion of hydrocarbons remains constant over time.

33. The method of claim 16, wherein the SPGM catalyst converts about 90% of hydrocarbons.

34. The SPGM catalyst of claim 33, wherein the about 90% conversion of hydrocarbons remains constant over time.
